(19) United States
(12) Patent Application Publication
(10) Pub. No.: US 2023/0212393 A1
(43) Pub. Date: Jul. 6, 2023

(54) MOLDING COMPOSITIONS BASED ON POLYAMIDE, ON CARBON FIBERS AND ON HOLLOW GLASS BEADS AND USE THEREOF

(71) Applicant: ARKEMA FRANCE, Colombes (FR)

(72) Inventors: Mathieu SABARD, Serquigny (FR); Fabrice GLASSON, Serquigny (FR); Cristian TITTOTO, Castelcucco (TV) (IT)

(73) Assignee: ARKEMA FRANCE, Colombes (FR)

(21) Appl. No.: 18/001,138

(22) PCT Filed: Jun. 14, 2021
(86) PCT No.: PCT/FR2021/051056

§ 371 Date: Dec. 8, 2022

(30) Foreign Application Priority Data
Jun. 15, 2020 (FR) 2006209

(51) Int. Cl. C08L 77/10; C08L 53/00; C08K 7/28; C08K 7/02; C08G 69/40

(52) U.S. Cl. CPC C08L 77/10; C08L 53/00; C08K 7/28; C08K 7/02; C08G 69/40; C08L 2203/20

(57) ABSTRACT

Molding composition, including by weight: (A) from 38 to 79.5% of at least one semi-crystalline aliphatic polyamide with the exclusion of PA6 and PA66, (B) from 10 to 20% of carbon fibres, (C) from 10 to 20% of hollow glass beads, (D) from 5.5 to 10% of at least one impact modifier having a flexural modulus of less than 200 MPa, in particular less than 100 MPa, as measured according to standard ISO 178: 2010, at 23° C., and (E) from 0.1 to 1% by weight of at least one additive, the sum of the proportions of each constituent (A)+(B)+(C)+(D)+(E) of the composition being equal to 100%.

The present invention relates to molding compositions based on polyamide, carbon fibers, impact modifiers and hollow glass beads and use thereof for the preparation of articles, particularly in the field of electronics, sports, motor vehicle or industry obtained by injection and having a low density, high rigidity, good impact properties and good processability.

Articles for electronics, sports, motor vehicle or industrial applications must all become lighter in order to consume less energy or minimize the energy expended when used in the context of sports in particular. They must also allow the athlete to obtain the necessary sensations for controlling movements and rapidly transmitting muscle pulses.

The rigidity of a part is directly related to the modulus of the constituent material of this part.

A material with a high modulus can reduce the thicknesses of the parts and therefore improve greatly on their weight while retaining the necessary rigidity for a good elastic springback indispensable for athletes.

Moreover, the articles must be able to be easily injected and enable parts to be obtained with an attractive appearance and an ability to be dyed in a variety of colors.

International application WO 2020/094624 describes the polyamide molding compositions consisting of the following compounds:

(A) 63.0-85.0% by weight of at least one polyamide selected from the group consisting of acyclic aliphatic polyamides with a C:N ratio of 7 to 13 (A1) and cycloaliphatic polyamides based on diamines MACM, PACM or TMDC (A2),
(B) 7.0-20.0% by weight of hollow glass spheres,
(C) 8.0-20.0% by weight of carbon fibers equally
(D) 0.0 to 5.0% by weight of at least one additive.

The sum of the constituents is equal to 100% and the composition cannot therefore contain anything else.

The additive is optional and is selected from a long list such as inorganic stabilizers, organic stabilizers, in particular antioxidants, antiozonants, light stabilizers, UV stabilizers, UV absorbers or UV blockers, IR absorbers, an NIR absorber, nucleating agents, crystallization accelerators, crystalline growth inhibitors, chain limiters, mold release agents, lubricants, dyes, labeling agents, organic pigments, carbon black, graphite, titanium dioxide, zinc sulfide, zinc oxide, barium sulfate, photochromic agents, antistatic agents, mold release agents, optical brighteners, halogen-free flame retardants, metal pigments, metal flakes, metal covered particles, fillers, various (C) reinforcement materials, natural layered silicates, synthetic layered silicates, impact modifiers and mixtures thereof.

The impact modifier, if present, is selected from a long list such as polyethylene, polypropylene, polyolefin copolymers, acrylate copolymers, acrylic acid copolymers, vinyl acetate copolymers, styrene copolymers, styrene block copolymers, ionic ethylene copolymers in which the acid groups are partially neutralized with metal ions, core-shell impact modifiers and mixtures thereof.

The impact modifier modulus is not mentioned and the polyether block amides (PEBAs) are absent from this long list.

The additives are present up to a maximum of 5% by weight and are preferentially present between 0.1 and 3%.

Application US2005/0238864 describes compositions comprising one or more thermoplastic resins, one or more fiber-based reinforcement fillers and hollow microspheres. Only PA66 is given as an example and the impact modifiers are not mentioned in this application.

Application JP 2007/119669 describes a polyamide composition comprising a polyamide resin, hollow glass beads and optionally an inorganic filler different from 1 glass beads. The composition may comprise an impact modifier without specifying the modulus thereof, and polyolefins and PEBAs are not mentioned in this application.

Application JP 2013/010847 describes a composition comprising 100 parts by weight of a polyamide resin, from 10 to 300 parts by weight of a carbon fiber and from 0.1 to 30 parts by weight of a spherical filler. The composition can comprise an impact modifier without specifying the modulus thereof, and polyolefins and PEBAs are not mentioned in this application.

Application JP 06-271763 describes a composition comprising a mixture of 100 parts by weight of a polyamide-based resin and from 5 to 200 parts by weight of hollow spheres having a mean particle diameter of less than or equal to 100 μm and optionally an inorganic filler that can be a carbon fiber. The impact modifiers are not mentioned in this application.

However, there remains a need to successfully formulate compositions having a low density, high rigidity, and good impact properties while conserving good processability.

The applicant has thus surprisingly discovered that selecting a particular range of impact modifiers with a particular modulus in a composition also comprising at least one semi-crystalline polyamide, hollow glass beads and carbon fibers makes it possible to prepare compositions having a low density, high rigidity, and good impact properties whilst conserving good processability.

The present invention relates to a molding composition, comprising by weight:

(A) from 38.0 to 79.5% of at least one semi-crystalline aliphatic polyamide,
(B) from 10.0 to 20.0% of carbon fibers,
(C) from 5.0 to 20.0% of hollow glass beads; and
(D) from 5.5% to 20.0% of at least one impact modifier having a flexural modulus of less than 200 MPa, in particular less than 100 MPa, as measured according to standard ISO 178:2010 at 23° C.
(E) from 0 to 2.0% by weight, preferably 0.1 to 1.0% by weight of at least one additive,
the sum of the proportions of each constituent (A)+(B)+(C)+(D)+(E) of said composition being equal to 100%,
In one embodiment, the composition defined above excludes PA6 and PA66.

In one embodiment, the composition defined above excludes nano alumina.

In another embodiment, the composition defined above excludes PA6 and PA66 and nano alumina.

The flexural modulus is determined in the dry state.

In the entire description, all the percentages are indicated by weight.

In the entire description, the limits of the ranges of values presented are included.

A semi-crystalline polyamide, for the purposes of the invention, denotes a polyamide that has a melting temperature (Tm) measured according to standard ISO 11357-3:2013 by DSC, and a crystallization enthalpy measured during the cooling step at a rate of 20 K/min by DSC according to ISO standard 11357-3 of 2013 greater than 30 J/g, preferably greater than 40 J/g.

The term “polyamide” used in the present description covers both homopolyamides and copolyamides.

### Regarding the Impact Modifier (D)

The impact modifier is a polymer having a flexural modulus of less than 200 MPa, in particular less than 100 MPa measured according to standard ISO 178:2010 at 23° C. in the dry state.

In one embodiment, the impact modifier is selected from a polyether block amide (PEBA), a functionalized or non-functionalized polyolefin and mixtures thereof.

The impact modifier is present from 5.5 to 20.0% by weight.

Advantageously, it is present from 5.5 to 10.0% by weight, more advantageously from 5.5 to 8.0% by weight.

### Regarding the PEBA.

Polyether block amides (PEBAs) are copolymers with amide units (Ba1) and polyether units (Ba2), said amide unit (Ba1) corresponding to an aliphatic repeating unit chosen from a unit obtained from at least one amino acid or a unit obtained from at least one lactam, or a unit X·Y obtained from the polycondensation:

of at least one diamine, said diamine being selected from a linear or branched aliphatic diamine, or an aromatic diamine or a mixture thereof, and

at least one dicarboxylic acid, said diacid being chosen from: an aliphatic diacid or an aromatic diacid,

said diamine and said diacid comprising 4 to 36 carbon atoms, advantageously 6 to 18 carbon atoms;
said polyether units (Ba2) being especially derived from at least one polyalkylene ether polyol, especially a polyalkylene ether diol,
PEBAs especially result from the copolycondensation of polyamide sequences with reactive ends with polyether sequences with reactive ends, such as, inter alia:
1) Polyamide sequences with diamine chain ends with polyoxyalkylene sequences with dicarboxylic chain ends.
2) Polyamide sequences with dicarboxylic chain ends with polyoxyalkylene sequences with diamine chain ends obtained by cyanoethylation and hydrogenation of alpha-omega dihydroxylated aliphatic polyoxyalkylene sequences referred to as polyalkylene ether diols (polyetherdiols).
3) Polyamide sequences with dicarboxylic chain ends with polyetherdiols, the products obtained being, in this particular case, polyether ester amides. The copolymers of the invention are advantageously of this type.

The polyamide sequences with dicarboxylic chain ends come for example from the condensation of polyamide precursors in the presence of a chain-limiting carboxylic diacid.

The polyamide sequences with diamine chain ends come for example from the condensation of polyamide precursors in the presence of a chain-limiting diamine.

The polyamide and polyether block polymers may also comprise randomly distributed units. These polymers may be prepared by the simultaneous reaction of polyether and polyamide block precursors.

For example, polyetherdiol, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Alternatively, polyetherdiamine, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

### Amide Unit (Ba1):

The amide unit (Ba1) corresponds to an aliphatic repeating unit as defined hereinbefore.

Advantageously, (Ba1) represents an amide unit obtained from 11-aminoundecanoic acid or an undecanolactam.

### Polyether Unit (Ba2):

The polyether units are especially derived from at least one polyalkylene ether polyol, in particular they are derived from at least one polyalkylene ether polyol, in other words, the polyether units consist of at least one polyalkylene ether polyol. In this embodiment, the expression “of at least one polyalkylene ether polyol” means that the polyether units consist exclusively of alcohol chain ends and therefore cannot be a polyetherdiamine triblock type compound.

The composition of the invention therefore is free of polyetherdiamine triblock.

The number average molecular weight of the polyether blocks is advantageously comprised from 200 to 4000 g/mol, preferably from 250 to 2500 g/mol, especially from 300 to 1100 g/mol.

The PEBA can be prepared by the following method in which:

in a first step, the polyamide blocks (Ba1) are prepared by polycondensation of the lactam(s), or

of the amino acid(s), or
of the diamine(s) and of the carboxylic diacid(s); and if necessary, of the comonomer(s) chosen from the lactams and the alpha-omega aminocarboxylic acids;
in the presence of a chain limiter chosen from the carboxylic diacids; then

in a second step, the polyamide blocks (Ba1) obtained are reacted with polyether blocks (Ba2) in the presence of a catalyst.

The general method for two-step preparation of the copolymers of the invention is known and is described, for example, in French patent FR 2 846 332 and in European patent EP 1 482 011.

The reaction for forming the block (Ba1) usually takes place between 180 and 300° C., preferably between 200 and 290° C., the pressure inside the reactor is between 5 and 30 bar, and is maintained for about 2 to 3 hours. The pressure is slowly reduced by bringing the reactor to atmospheric pressure, and then the excess water is distilled off, for example for an hour or two.

Once the polyamide with carboxylic acid ends has been prepared, the polyether and a catalyst are added. The polyether may be added in one or several stages, as can the catalyst. In an advantageous embodiment, the polyether is added first, the reaction of the OH ends of the polyether and the COOH ends of the polyamide begins with the formation of ester bonds and the removal of water. As much water as possible is removed from the reaction medium by distillation, then the catalyst is introduced to complete the bonding of the polyamide blocks and the polyether blocks. This second step is carried out under stirring, preferably under a vacuum of at least 15 mm Hg (2000 Pa) at a temperature such that the reagents and copolymers obtained are in the molten state. As an example, this temperature can be comprised between 100 and 400° C. and most commonly 200 and 300° C. The reaction is monitored by measuring the torque exerted by the molten polymer on the stirrer or by measuring the electrical power consumed by the stirrer. The end of the reaction is determined by the value of the target torque or power.

One or several molecules used as antioxidant, for example Irganox® 1010 or Irganox® 245, may also be added during the synthesis, at the moment deemed most appropriate.

The PEBA preparation process may also be considered so that all the monomers are added at the beginning, in a single step, in order to perform the polycondensation:

of the lactam(s), or
of the amino acid(s), or
of the diamine(s) and the carboxylic diacid(s); and optionally, of the other polyamide comonomer(s);

in the presence of a chain limiter chosen from the carboxylic diacids;

in the presence of the blocks (Ba2) (polyether);

in the presence of a catalyst for the reaction between the soft blocks (Ba2) and the blocks (Ba1).

Advantageously, said carboxylic diacid is used as a chain limiter, which is introduced in excess with respect to the stoichiometry of the diamine(s).

Advantageously, a derivative of a metal chosen from the group formed by titanium, zirconium and hafnium or a strong acid such as phosphoric acid, hypophosphorous acid or boric acid is used as catalyst.

The polycondensation can be carried out at a temperature of 240 to 280° C.

Generally speaking, the known copolymers with ether and amide units consist of linear and semi-crystalline aliphatic polyamide sequences (for example Arkema's “Pebax”).

### Regarding the Polyolefin:

The polyolefin of the impact modifier may be functionalized or non-functionalized or be a mixture of at least one functionalized polyolefin and/or least one non-functionalized polyolefin. To simplify, the polyolefin is denoted (P) and functionalized polyolefins (P1) and non-functionalized polyolefins (P2) are described below.

A non-functionalized polyolefin (P2) is classically a homopolymer or copolymer of alpha-olefins or diolefins, such as for example, ethylene, propylene, 1-butene, 1-octene, butadiene. By way of example, mention may be made of:

the homopolymers and copolymers of polyethylene, particularly LDPE, HDPE, LLDPE (linear low-density polyethylene), VLDPE (very low density polyethylene) and metallocene polyethylene.

homopolymers or copolymers of propylene.
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.

copolymers of ethylene with at least one product chosen from the salts or esters of unsaturated carboxylic acids such as alkyl (meth)acrylate (for example methyl acrylate), or the vinyl esters of saturated carboxylic acids such as vinyl acetate (EVA), where the proportion of comonomer can reach 40% by weight.

The functionalized polyolefin (P1) may be a polymer of alpha-olefins having reactive units (functionalities); such reactive units are acid, anhydride, or epoxy functions. By way of example, mention may be made of the preceding polyolefins (P2) grafted or co- or ter-polymerized by unsaturated epoxides such as glycidyl (meth)acrylate, or by carboxylic acids or the corresponding salts or esters such as (meth)acrylic acid (which can be completely or partially neutralized by metals such as Zn, etc.) or even by carboxylic acid anhydrides such as maleic anhydride. A functionalized polyolefin is for example a PE/EPR mixture, the ratio by weight whereof can vary widely, for example between 40/60 and 90/10, said mixture being co-grafted with an anhydride, especially maleic anhydride, according to a graft rate for example of 0.01 to 5% by weight.

The functionalized polyolefin (P1) may be chosen from the following, maleic anhydride or glycidyl methacrylate grafted, (co)polymers wherein the graft rate is for example from 0.01 to 5% by weight:

of PE, of PP, of copolymers of ethylene with propylene, butene, hexene, or octene containing for example from 35 to 80% by weight of ethylene;
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.

of ethylene and vinyl acetate copolymers (EVA), containing up to 40% by weight of vinyl acetate;

of ethylene and alkyl (meth)acrylate copolymers, containing up to 40% by weight of alkyl (meth)acrylate;

of ethylene and vinyl acetate (EVA) and alkyl (meth)acrylate copolymers, containing up to 40% by weight of comonomers.

The functionalized polyolefin (P1) may also be selected from ethylene/propylene copolymers with predominantly maleic anhydride grafted propylene then condensed with a mono-amine polyamide (or a polyamide oligomer) (products described in EP-A-0342066).

The functionalized polyolefin (P1) may also be a co- or terpolymer of at least the following units: (1) ethylene, (2) alkyl (meth)acrylate or vinyl ester of saturated carboxylic acid and (3) anhydride such as maleic anhydride or (meth)acrylic acid or epoxy such as glycidyl (meth)acrylate.

By way of example of functionalized polyolefins of the latter type, mention may be made of the following copolymers, where ethylene represents preferably at least 60% by weight and where the termonomer (the function) represents for example from 0.1 to 10% by weight of the copolymer:

ethylene/alkyl (meth)acrylate/(meth)acrylic acid or maleic anhydride or glycidyl methacrylate copolymers;

ethylene/vinyl acetate/maleic anhydride or glycidyl methacrylate copolymers;

ethylene/vinyl acetate or alkyl (meth)acrylate/(meth)acrylic acid or maleic anhydride or glycidyl methacrylate copolymers.

In the preceding copolymers, (meth)acrylic acid can be salified with Zn or Li.

The term “alkyl (meth)acrylate” in (P1) or (P2) denotes C1 to C8 alkyl methacrylates and acrylates, and may be chosen from methyl acrylate, ethyl acrylate, n-butyl acrylate, isobutyl acrylate, 2-ethyl-hexyl acrylate, cyclohexyl acrylate, methyl methacrylate and ethyl methacrylate.

Moreover, the previously cited polyolefins (P1) may also be crosslinked by any appropriate method or agent (diepoxy, diacid, peroxide, etc.); the term functionalized polyolefin also comprises mixtures of the previously cited polyolefins with a difunctional reagent such as a diacid, dianhydride, diepoxy, etc. that can react with these or mixtures of at least two functionalized polyolefins that can react together.

The copolymers mentioned above, (P1) and (P2), may be copolymerized in a statistical or sequenced way and have a linear or branched structure.

The molecular weight, the index MFI, the density of these polyolefins may also vary widely, which the person skilled in the art will know. MFI, abbreviation for Melt Flow Index, is a measure of fluidity in the molten state. It is measured according to standard ASTM 1238.

Advantageously the non-functionalized polyolefins (P2) are selected from homopolymers or copolymers of polypropylene and any ethylene homopolymer or ethylene copolymer and a higher alpha-olefin comonomer such as butene, hexene, octene or 4-methyl-1-pentene. Mention may be made for example of PPs, high-density PEs, medium-density PEs, linear low-density PEs, low-density PEs, very low-density PEs. These polyethylenes are known by the person skilled in the art as being produced according to a “free-radical” method, according to a “Ziegler” catalysis method, or, more recently, a so-called “metallocene” catalysis.

Advantageously, the impact modifier is selected from Fusabond® F493, Tafmer MH5020, a Lotader®, for example Lotader® 4700, Exxelor® VA1803, VA1801 and VA 1840, Orevac® IM800 or a mixture thereof; in this case, they are in a ratio ranging from 0.1:99.9 to 99.9:0.1, Kratons® FG 1901, FG 1924, MD 1653, Tuftec® M1913, M1911 and M 1943, and a Pebax®, in particular Pebax® 40R53 SP01.

In one embodiment, the impact modifier is selected from a polyether block amide (PEBA) having a flexural modulus less than 200 MPa, in particular less than 100 MPa as measured according to standard ISO 178:2010 at 23° C. as defined above, and a mixture of polyether block amide (PEBA) having a flexural modulus less than 200 MPa, in particular less than 100 MPa as measured according to standard ISO 178:2010 at 23° C. with a functionalized or non-functionalized polyolefin as defined above.

Advantageously, the PEBA has a density greater than or equal to 1, in particular greater than 1, as determined according to ISO 1183-3: 1999.

In another embodiment, the impact modifier is selected from a functionalized polyolefin, a non-functionalized polyolefin and mixtures thereof, said impact modifier being present from 7.0 to 20.0%, in particular from 10.0 to 20.0% relative to the total weight of the composition.

Advantageously, the functionalized polyolefin has a function selected from the maleic anhydride, carboxylic acid, carboxylic anhydride and epoxide functions, and is in particular selected from the ethylene/octene copolymers, ethylene/butene copolymers, ethylene/propylene (EPR) elastomers, elastomeric ethylene-propylene-diene copolymers (EPDM) and ethylene/alkyl (meth)acrylate copolymers.

In one embodiment, the impact modifier excludes maleic anhydride-grafted elastomeric ethylene-propylene-diene copolymers (EPDM).

### Regarding the Semi-Crystalline Aliphatic Polyamide (A):

The mean number of carbon atoms relative to the nitrogen atom is greater than or equal to 6.

Advantageously, the semi-crystalline aliphatic polyamide excludes PA6 and PA66.

Advantageously, it is greater than or equal to 8.

In the case of a PA-X·Y homopolyamide, the number of carbon atoms per nitrogen atom is the mean of unit X and unit Y.

In the case of a copolyamide, the number of carbons per nitrogen is calculated according to the same principle. The molar ratios of the various amide units are used for the calculation.

### In a First Embodiment

In a first variant of this first embodiment, the semi-crystalline aliphatic polyamide is obtained from the polycondensation of at least one aminocarboxylic acid comprising 6 to 18 carbon atoms, preferentially 8 to 12 carbon atoms, more preferentially 10 to 12 carbon atoms. It can thus be chosen from 6-aminohexanoic acid, 7-aminoheptanoic acid, 8-aminooctanoic acid, 9-aminononanoic acid, 10-aminodecanoic acid, 11-aminoundecanoic acid and 12-aminododecanoic acid, 13-aminotridecanoic acid, 14-aminotetradecanoic acid, 15-aminopentadecanoic acid, 16-aminohexadecanoic acid, 17-aminoheptadecanoic acid and 18-aminooctadecanoic acid.

Preferentially, it is obtained from the polycondensation of a single aminocarboxylic acid.

In a second variant of this first embodiment, the semi-crystalline aliphatic polyamide is obtained from the polycondensation of at least one lactam comprising 6 to 18 carbon atoms, preferentially 8 to 12 carbon atoms, more preferentially 10 to 12 carbon atoms.

Preferentially, it is obtained from the polycondensation of a single lactam.

In a third variant of this first embodiment, the semi-crystalline aliphatic polyamide is obtained from the polycondensation of at least one aliphatic diamine comprising 4 to 36 carbon atoms, advantageously 6 to 18 carbon atoms, advantageously 6 to 12 carbon atoms, advantageously 10 to 12 carbon atoms and at least one aliphatic dicarboxylic acid comprising 4 to 36 carbon atoms, advantageously 6 to 18 carbon atoms, advantageously 6 to 12 carbon atoms, advantageously 8 to 12 carbon atoms.

The aliphatic diamine used to produce this repeating unit X·Y is an aliphatic diamine that has a linear main chain comprising at least 4 carbon atoms.

This linear main chain can, if necessary, include one or more methyl and/or ethyl substituents; in the latter configuration, this is called a “branched aliphatic diamine”. In the case where the main chain does not include any substituent, the aliphatic diamine is called a “linear aliphatic diamine.”

Whether or not it includes methyl and/or ethyl substituents on the main chain, the aliphatic diamine used to produce this repeating unit X·Y comprises from 4 to 36 carbon atoms, advantageously from 4 to 18 carbon atoms, advantageously from 6 to 18 carbon atoms, advantageously from 6 to 14 carbon atoms.

When this diamine is a linear aliphatic diamine, it then meets the formula H₂N—(CH₂)ₓ—NH₂ and can be chosen for example from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines that have just been mentioned can all be bio-sourced in the sense of standard ASTM D6866.

When this diamine is a branched aliphatic diamine, it can in particular be 2-methyl-pentanediamine, 2-methyl-1,8-octanediamine or trimethylene (2,2,4 or 2,4,4) hexanediamine.

The dicarboxylic acid can be chosen from the linear or branched aliphatic dicarboxylic acids.

When the dicarboxylic acid is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanoic acid (18), octadecenedioic acid (18), eicosanedioic acid (20), docosanedioic acid (22) and fatty acid dimers containing 36 carbons.

The fatty acid dimers mentioned above are dimerized fatty acids obtained by oligomerization or polymerization of monobasic unsaturated long-chain hydrocarbon fatty acids (such as linoleic acid and oleic acid), as described in particular in document EP 0,471,566.

In a fourth variant of this first embodiment, the semi-crystalline aliphatic polyamide is obtained from a mixture of these three variants.

### In a Second Embodiment

In a first variant of this second embodiment, the semi-crystalline aliphatic polyamide is obtained from the polycondensation of at least one aminocarboxylic acid comprising 6 to 18 carbon atoms, preferentially 8 to 12 carbon atoms, more preferentially 10 to 12 carbon atoms.

Preferentially, it is obtained from the polycondensation of a single aminocarboxylic acid.

In a second variant of this second embodiment, the semi-crystalline aliphatic polyamide is obtained from the polycondensation of at least one lactam comprising 6 to 18 carbon atoms, preferentially 8 to 12 carbon atoms, more preferentially 10 to 12 carbon atoms.

Preferentially, it is obtained from the polycondensation of a single lactam.

In a third embodiment, said semi-crystalline polyamide is selected from PA610, PA612, PA1010, PA1012, PA1212, PA11 and PA12, in particular PA1010, PA1012, PA1212, PA11, PA12.

Advantageously, said semi-crystalline polyamide is selected from PA11 and PA12, in particular PA11.

Regarding the additive (E): The additive is optional and comprised from 0 to 2.0%, in particular from 0.1 to 1.0% by weight.

The additive is chosen from fillers, dyes, stabilizers, plasticizers, surfactants, nucleating agents, pigments, brighteners, antioxidants, lubricants, flame retardants, natural waxes, and mixtures thereof.

Advantageously, the additive is chosen from fillers, dyes, stabilizers, plasticizers, surfactants, nucleating agents, pigments, brighteners, antioxidants, flame retardants, natural waxes, and mixtures thereof.

As an example, the stabilizer may be a UV stabilizer, an organic stabilizer or more generally a combination of organic stabilizers, such as a phenol antioxidant (for example of the type Irganox 245 or 1098 or 1010 by Ciba-BASF), a phosphite antioxidant (for example Irgafos® 126 by Ciba-BASF) and even optionally other stabilizers like a HALS, which means hindered amine light stabilizer (for example Tinuvin 770 by Ciba-BASF), an anti-UV (for example Tinuvin 312 by Ciba), a phosphorus-based stabilizer. Amine antioxidants such as Crompton's Naugard 445 or even polyfunctional stabilizers such as Clariant's Nylostab S-EED may also be used.

This stabilizer may also be a mineral stabilizer, such as a copper-based stabilizer. By way of example of such mineral stabilizers, mention may be made of halides and copper acetates. Secondarily, other metals such as silver may optionally be considered, but these are known to be less effective.

These copper-based compounds are typically associated with alkali metal halides, particularly potassium.

By way of example, the plasticizers are chosen from benzene sulfonamide derivatives, such as n-butyl benzene sulfonamide (BBSA); ethyl toluene sulfonamide or N-cyclohexyl toluene sulfonamide; hydroxybenzoic acid esters, such as 2-ethylhexyl parahydroxybenzoate and 2-decylhexyl parahydroxybenzoate; esters or ethers of tetrahydrofurfuryl alcohol, like oligoethyleneoxytetrahydrofurfuryl alcohol; and esters of citric acid or of hydroxy-malonic acid, such as oligoethyleneoxy malonate.

Using a mixture of plasticizers would not be outside the scope of the invention.

By way of example, the fillers can be selected from silica, graphite, expanded graphite, carbon black, kaolin, magnesia, slag, talc, wollastonite, nanofillers (carbon nanotubes), pigments, metal oxides (titanium oxide), metals, advantageously wollastonite and talc, preferentially talc.

### Regarding Carbon Fibers (B):

The carbon fibers in the semi-crystalline aliphatic polyamide molding composition according to the invention are preferably present from 10.0 to 20.0% by weight, preferably from 10.0 to 15.0%, preferably from 12.0 to 20.0% by weight, each based on the sum of the constituents of the composition.

The carbon fibers used in the semi-crystalline aliphatic polyamide molding composition may be in the form of cut (or short) fibers or in the form of cut (or short) fiber bundles or in the form of crushed carbon fibers.

Before compounding, the carbon fibers are preferentially cut (or short) carbon fibers and have a length with an arithmetic mean comprised from 0.1 to 50 mm, in particular between 2 and 10 mm.

Before compounding, the crushed carbon fibers have a length with an arithmetic mean comprised from 50 μm to 400 μm.

After compounding, in the composition to be molded, the crushed carbon fibers have a length with an arithmetic mean of less than 400 μm.

After compounding, in the composition to be molded, the short carbon fibers have a length with an arithmetic mean comprised from 100 to 600 μm, in particular from 150 to 500 μm.

The length of fibers having an arithmetic mean as defined above is determined according to ISO 22314:2006 (E).

The carbon fibers can be manufactured, for example, from PAN (polyacrylonitrile), or carbon pitch or cellulose-based fibers.

The carbon fibers in the composition can also be anisotropes.

The carbon fibers used in the polyamide composition have a diameter comprised between 5 and 10 μm, a tensile strength of 1000 to 7000 MPa and an elastic modulus of 200 to 700 GPa.

Usually, the carbon fibers are produced by exposing an appropriate polymer fiber made from polyacrylonitrile, pitch or rayon under changing controlled atmospheric and temperature conditions. For example, carbon fibers can be produced by stabilizing PAN yarns or fabrics in an oxidizing atmosphere at 200 to 300 degrees Celsius and subsequent carbonization in an inert atmosphere above 600 degrees Celsius. Such methods are cutting-edge and disclosed, for example, in H. Heissler, “Reinforced plastics in the aerospace industry”, Verlag W. Kohlhammer, Stuttgart, 1986.

With the aim of improving the physicochemical links between polymer and fibers, fiber manufacturers use sizings, the composition and level of which may vary.

The term “sizing” refers to the surface treatments applied to the reinforcing fibers leaving the nozzle (textile sizing) and on the fabrics (plastic sizing). They are generally organic in nature (thermosetting or thermoplastic resin type).

“Textile” sizing applied on the fibers leaving the die consists of depositing a bonding agent ensuring the cohesion of the fibers relative to one another, decreasing abrasion and facilitating subsequent handling (weaving, draping, knitting) and preventing the formation of electrostatic charges.

“Plastic” sizing or “finish” applied on fabrics consists of depositing a bonding agent, the roles of which are to ensure a physicochemical bond between the fibers and the resin and to protect the fiber from its environment.

In one embodiment, the carbon fiber of the component can be a recycled carbon fiber.

### Regarding Hollow Glass Beads (C):

The hollow glass beads are present in the composition from 5.0 to 20.0% by weight.

Advantageously, they are present from 7.0 to 20% by weight, in particular from 10.0 to 20.0% by weight, notably from 12.0 to 20.0% by weight.

The hollow glass beads have a compression resistance, measured according to ASTM D 3102-72 (1982) in glycerol, of at least 50 MPa and in a particularly preferred manner of at least 100 MPa.

Advantageously, the hollow glass beads have a mean volume diameter d50 from 10 to 80 μm, preferably from 13 to 50 μm, measured using laser diffraction in accordance with standard ASTM B 822-10.

The hollow glass beads can be surface treated with, for example, systems based on aminosilanes, epoxy silanes, polyamides, in particular hydrosoluble polyamides, fatty acids, waxes, silanes, titanates, urethanes, polyhydroxyethers, epoxides, nickel or mixtures thereof can be used for this purpose. The hollow glass beads are preferably surface treated with aminosilanes, epoxy silanes, polyamides or mixtures thereof.

The hollow glass beads can be formed from a borosilicate glass, preferably from a calcium-borosilicate sodium-oxide carbonate glass. The hollow glass beads preferably have a real density of 0.10 to 0.65 g/cm3, preferably 0.20 to 0.60 g/cm3, particularly preferably 0.30 to 0.50 g/cm3, measured according to standard ASTM D 2840-69 (1976) with a gas pycnometer and helium as the measuring gas.

### Regarding the Composition:

The molding composition is as defined above and comprises by weight:

(A) from 38 to 79.5% of at least one semi-crystalline aliphatic polyamide,
(B) from 10.0 to 20.0% of carbon fibers,
(C) from 5.0 to 20.0% of hollow glass beads; and
(D) from 5.5% to 20.0% of at least one impact modifier having a flexural modulus of less than 200 MPa, in particular less than 100 MPa, as measured according to standard ISO 178:2010 at 23° C.
(E) from 0 to 2.0% by weight, preferably 0.1 to 1.0% by weight of at least one additive,
the sum of the proportions of each constituent (A)+(B)+(C)+(D)+(E) of said composition being equal to 100%.

The composition can also comprise solid and/or hollow glass fibers.

Advantageously, it is free of solid and/or hollow glass fibers.

In one embodiment, the molding composition consists of (by weight):

(A) from 38 to 79.5% of at least one semi-crystalline aliphatic polyamide,
(B) from 10.0 to 20.0% of carbon fibers,
(C) from 5.0 to 20.0% of hollow glass beads; and
(D) from 5.5% to 20.0% of at least one impact modifier having a flexural modulus of less than 200 MPa, in particular less than 100 MPa, as measured according to standard ISO 178:2010 at 23° C.
(E) from 0 to 2.0% by weight, preferably 0.1 to 1.0% by weight of at least one additive,
the sum of the proportions of each constituent (A)+(B)+(C)+(D)+(E) of said composition being equal to 100%.

In another embodiment where the impact modifier is selected from a polyether block amide (PEBA) having a flexural modulus less than 200 MPa, in particular less than 100 MPa as measured according to standard ISO 178:2010 at 23° C. as defined above, and a mixture of polyether block amide (PEBA) having a flexural modulus less than 200 MPa, in particular less than 100 MPa as measured according to ISO standard 178:2010 at 23° C. with a functionalized or non-functionalized polyolefin as defined above, the composition then comprises:

(A) from 38 to 79.5% of at least one semi-crystalline aliphatic polyamide,
(B) from 10.0 to 20.0% of carbon fibers,
(C) from 5.0 to 20.0% of hollow glass beads; and
(D) from 5.5 to 20.0% of at least one impact modifier having a flexural modulus of less than 200 MPa, in particular less than 100 MPa as measured according to standard ISO 178:2010, at 23° C., selected from a polyether block amide (PEBA) having a flexural modulus of less than 200 MPa, in particular less than 100 MPa as measured according to standard ISO 178:2010 at 23° C. as defined above, and a mixture of polyether block amide (PEBA) having a flexural modulus of less than 100 MPa as measured according to standard ISO 178:2010 at 23° C. with a functionalized or non-functionalized polyolefin as defined above,
(E) from 0 to 2.0% by weight, preferably 0.1 to 1.0% by weight of at least one additive,
the sum of the proportions of each constituent of said composition being equal to 100%.

In yet another embodiment, the composition consists of:

(A) from 38 to 79.5% of at least one semi-crystalline aliphatic polyamide,
(B) from 10.0 to 20.0% of carbon fibers,
(C) from 5.0 to 20.0% of hollow glass beads; and
(D) from 5.5 to 20.0% of at least one impact modifier having a flexural modulus of less than 200 MPa, in particular less than 100 MPa as measured according to standard ISO 178:2010, at 23° C., selected from a polyether block amide (PEBA) having a flexural modulus of less than 200 MPa, in particular less than 100 MPa as measured according to standard ISO 178:2010 at 23° C. as defined above, and mixture of polyether block amide (PEBA) having a flexural modulus of less than 200 MPa, in particular less than 100 MPa as measured according to standard ISO 178:2010 at 23° C. with a functionalized or non-functionalized polyolefin as defined above,
(E) from 0 to 2% by weight, preferably 0.1 to 1% by weight of at least one additive, the sum of the proportions of each constituent of said composition being equal to 100%.

In another embodiment wherein the impact modifier is selected from selected from a functionalized polyolefin, a non-functionalized polyolefin and mixtures thereof, the composition then comprises:

(A) from 38.0 to 78.0% of at least one semi-crystalline aliphatic polyamide,
(B) from 10.0 to 20.0% of carbon fibers,
(C) from 5.0 to 20.0% of hollow glass beads; and
(D) from 7.0% to 20.0% of at least one impact modifier having a flexural modulus of less than 200 MPa, in particular less than 100 MPa, as measured according to standard ISO 178:2010 at 23° C., selected from a functionalized polyolefin, a non-functionalized polyolefin and mixtures thereof,
(E) from 0 to 2.0% by weight, preferably 0.1 to 1.0% by weight of at least one additive,
the sum of the proportions of each constituent of said composition being equal to 100%.

In yet another embodiment, the composition consists of:

(A) from 38.0 to 78.0% of at least one semi-crystalline aliphatic polyamide,
(B) from 10.0 to 20.0% of carbon fibers,
(C) from 5.0 to 20.0% of hollow glass beads; and
(D) from 7.0% to 20.0% of at least one impact modifier having a flexural modulus of less than 200 MPa, in particular less than 100 MPa, as measured according to standard ISO 178:2010 at 23° C., selected from a functionalized polyolefin, a non-functionalized polyolefin and mixtures thereof
(E) from 0 to 2.0% by weight, preferably 0.1 to 1.0% by weight of at least one additive,
the sum of the proportions of each constituent of said composition being equal to 100%.

For each of these embodiments, the composition, when it comprises an additive between 0.1 and 1.0%, then the maximum limit of the proportion of semi-crystalline polyamide is lowered by the proportion of additive present in order to reach a constituent total of 100%.

In an advantageous embodiment, the present invention relates to a composition as defined above, wherein the semi-crystalline composition is (are) partially or totally biobased.

The term “biobased” has the same meaning as in standard ASTM D6852-02 and, more preferentially, as in standard ASTM D6866.

Standard ASTM D6852 indicates the proportion of naturally occurring products in the composition whereas standard ASTM D6866 specifies the method and the conditions for measuring renewable organic carbon, i.e. from biomass.

According to another aspect, the present invention relates to the use of a composition as defined above, for the production of an article, notably for electronics, sports, motor vehicles or industry.

All the technical characteristics defined above for the composition as such are also valid for the use thereof.

In one embodiment, the article is manufactured by injection molding.

According to yet another aspect, the present invention relates to an article obtained by injection molding with a composition as defined above.

All the technical characteristics detailed above for the composition as such are valid for the article.

### EXAMPLES

Preparation of the Compositions of the Invention and Mechanical Properties:

The compositions of tables I and II were prepared by melt blending polymer granules with the carbon fibers, the hollow glass beads and the additives. This mixture was made by compounding on a 26-mm diameter twin-screw co-rotating extruder with a flat temperature profile)(T° at 240° C. The screw speed is 200 rpm and the flow rate is 16 kg/h.

The introduction of carbon fibers and hollow glass beads is carried out with a side feeder.

The polyamide(s) and the additives are added during the compounding process in the main hopper.

The compositions were then molded on an injection molding machine at a material temperature of 260° C. and a molding temperature of 60° C. in the shape of dumbbells or bars in order to study the mechanical properties according to the standards below

TABLE I

| Batch no. | CE 1 | CE 2 | CE 3 | CE 4 | CE 5 | CE 6 |
|---|---|---|---|---|---|---|
| PA11 | 74.5 | 70 | 70 | 70 | 70 | 70 |
| iM16k hollow glass | 10.00 | 10.00 | 10.00 | 10.00 | 10.00 | 10.00 |
| beads | | | | | | |
| PEBA11/PTMG 50% | | 4.5 | | | | |
| PTMG, d = 1.03 | | | | | | |
| PEBA 11/PTMG 4% | | | 4.5 | | | |
| PTMG, d = 1.03 | | | | | | |
| Engage ™ 8200 | | | | 4.5 | | |
| Exxelor ™ VA1803 | | | | | 4.5 | |
| Kraton ™ FG 1901 | | | | | | 4.5 |
| Teijin ™ Toho Tenax | 15.00 | 15.00 | 15.00 | 15.00 | 15.00 | 15.00 |
| HT C493 carbon fiber | | | | | | |
| additives | 0.5 | 0.5 | 0.5 | 0.5 | 0.5 | 0.5 |
| density (g/cm3) | 1.007 | 1.004 | 1.004 | 1.005 | 1.005 | 1.005 |
| Tensile modulus | 11.4 | 10.8 | 11 | 10.8 | 10.7 | 10.7 |
| (GPa) | | | | | | |
| ISO 527-1: 2012 | | | | | | |
| Tensile strength MPa | 127.2 | 117.6 | 120.2 | 115.3 | 114.2 | 115.2 |
| Elongation at break % | 2.9 | 2.9 | 2.8 | 2.7 | 3 | 3.1 |
| Notched impact | 8.7 | 8.9 | 8.8 | 7.2 | 9.1 | 9.0 |
| according to ISO179: | | | | | | |
| 1eA at 23° C., strength | | | | | | |
| (kJ/m²) | | | | | | |
| Non-notched impact at | 45.8 | 46 | 45.9 | 43.2 | 46.2 | 45.9 |
| 23° C., strength (kJ/m²) | | | | | | |
| Notched impact | 6.4 | 6.5 | 6.4 | 7.1 | 6.7 | 6.6 |
| according to ISO179: | | | | | | |
| 1eA at −30° C., strength | | | | | | |
| (kJ/m²) | | | | | | |
| Non-notched impact | 47.1 | 47.3 | 47 | 45.2 | 47.4 | 47.3 |
| at −30° C., strength | | | | | | |
| (kJ/m²) | | | | | | |

CE: Counter-example

The proportions are given in mass proportion (%)

Engage™ 8200, non-functionalized ethylene-octene copolymer, d=0.87 g/cm3, supplied by the company Dow Inc
iM16k hollow glass beads, with a real density=0.46 g/cm3, average diameter=20 μm having a compression strength >100 MPa, supplied by the company 3M Kraton™ FG 1901: linear triblock copolymer based on styrene and ethylene/butylene, functionalized with maleic anhydride, d=0.91 g/cm3, supplied by the company Kraton Polymers
Exxelor™ VA1803, functionalized ethylene copolymer with maleic anhydride, d=0.86 g/cm3, supplied by the company Exxon Mobil
Toho Tenax HT C493: carbon fiber supplied by the company Teijin
PA11: synthesized by the applicant
PEBA PA11/PTMG: synthesized by the applicant

The tensile modulus, elongation at break and tensile strength were measured at 23° C. according to standard ISO 527-1: 2012 on dry samples.

The machine used is of the INSTRON 5966 type. The speed of the crosshead is 1 mm/min for the modulus measurement and 5 mm/min for the tensile strength and elongation at break. The test conditions are 23° C.+/−2° C., on dry samples.

The impact strength was determined according to ISO 179-1: 2010 (Charpy impact) on samples of dimension 80 mm×10 mm×4 mm, notched and non-notched, at a temperature of 23° C.+/−2° C. at a relative humidity of 50%+/−10% or at −30° C.+/−2° C. at a relative humidity of 50%+/−10% on dry samples.

The density of the compositions injected was measured according to standard ISO 1183-3:1999.

TABLE II

| Batch no. | EX 1 | EX 2 | EX 3 | EX 4 | EX 5 | EX 6 | EX 7 | EX 8 | EX 9 | EX 10 |
|---|---|---|---|---|---|---|---|---|---|---|
| PA11 | 69 | 67 | 64.5 | 59.5 | 67 | 69 | 67 | 64.5 | 59.5 | 67 |
| iM16k hollow | 10.0 | 10.0 | 10.0 | 10.0 | 10.0 | 10.0 | 10.0 | 10.0 | 10.0 | 10.0 |
| glass beads | | | | | | | | | | |
| PEBA 11/PTMG | 5.5 | 7.5 | 10.0 | 15.0 | | | | | | 3.75 |
| 50% PTMG, | | | | | | | | | | |
| d = 1.03 | | | | | | | | | | |
| Exxelor ™ | | | | | | 5.5 | 7.5 | 10.0 | 15.0 | 3.75 |
| VA1803 | | | | | | | | | | |
| VA1803 | | | | | | | | | | |
| Kraton ™ | | | | | 7.5 | | | | | |
| FG 1901 | | | | | | | | | | |
| Teijin ™ Toho | 15.0 | 15.0 | 15.00 | 15.0 | 15.0 | 15.0 | 15.0 | 15.0 | 15.0 | 15.0 |
| Tenax HT | | | | | | | | | | |
| C493 carbon | | | | | | | | | | |
| fiber | | | | | | | | | | |
| additives | 0.5 | 0.5 | 0.5 | 0.5 | 0.5 | 0.5 | 0.5 | 0.5 | 0.5 | 0.5 |
| density | 1.004 | 1.005 | 1.006 | 1.007 | 1.001 | 1.004 | 1.001 | 0.998 | 0.988 | 1.002 |
| (g/cm3) | | | | | | | | | | |
| Tensile | 10.7 | 10.5 | 10.4 | 9.9 | 10 | 10.5 | 10.1 | 9.6 | 8.6 | 10.3 |
| modulus (GPa) | | | | | | | | | | |
| ISO 527- | | | | | | | | | | |
| 1: 2012 | | | | | | | | | | |
| Tensile | 116.3 | 114.5 | 113.4 | 109.9 | 104.1 | 109.3 | 103.7 | 98.4 | 87.5 | 109.2 |
| strength MPa | | | | | | | | | | |
| Elongation at | 3 | 3.2 | 3.3 | 3.6 | 4.0 | 3.6 | 4.1 | 4.4 | 5.5 | 3.8 |
| break % | | | | | | | | | | |
| Notched | 10.1 | 10.9 | 11.6 | 13.2 | 16 | 14.3 | 16.5 | 18.7 | 21.9 | 15.3 |
| impact 1eA | | | | | | | | | | |
| at 23° C., | | | | | | | | | | |
| strength | | | | | | | | | | |
| (kJ/m²) | | | | | | | | | | |
| Non-notched | 48.5 | 51 | 52.2 | 52.6 | 49.9 | 47.7 | 50.2 | 53.6 | 56.6 | 51.8 |
| impact at | | | | | | | | | | |
| 23° C., | | | | | | | | | | |
| strength | | | | | | | | | | |
| (kJ/m²) | | | | | | | | | | |
| Notched | 7.2 | 7.3 | 7.3 | 8.8 | 11.1 | 9.4 | 11.2 | 12.4 | 15.5 | 9.8 |
| impact 1eA | | | | | | | | | | |
| at −30° | | | | | | | | | | |
| C., strength | | | | | | | | | | |
| (kJ/m²) | | | | | | | | | | |
| Non-notched | 50.1 | 50.4 | 50.5 | 53.8 | 50.9 | 48.7 | 51.3 | 54.5 | 56.7 | 51.1 |
| impact at −30° | | | | | | | | | | |
| C., strength | | | | | | | | | | |
| (kJ/m²) | | | | | | | | | | |

EX: Examples according to the invention
The proportions are given in mass proportion (%).

The results presented in tables I and II show that the compositions of the invention have superior mechanical properties to comparative compositions and notably Charpy impact values at −30° C. far superior to comparative compositions.

Moreover, elongation at break is superior for the compositions of the invention relative to comparative compositions.

The compositions of the invention also have excellent processability.

1. A molding composition, comprising by weight:
(A) from 38 to 79.5% of at least one semi-crystalline aliphatic polyamide,
(B) from 10 to 20% of carbon fibers,
(C) from 10 to 20% of hollow glass beads,
(D) from 5.5% to 20% of at least one impact modifier having a flexural modulus of less than 200 MPa, as measured according to standard ISO 178:2010 at 23° C., and
(E) from 0.1 to 1% by weight of at least one additive selected from the fillers selected from silica, graphite, expanded graphite, carbon black, kaolin, magnesia, slag, talc, wollastonite, nanofillers (carbon nanotubes), pigments, metal oxides (titanium oxide), metals, dyes, stabilizers, plasticizers, surfactants, nucleating agents, pigments, brighteners, antioxidants, lubricants, flame retardants, natural waxes and mixtures thereof, the sum of the proportions of each constituent (A)+(B)+(C)+(D)+(E) of said composition being equal to 100%,
excluding PA6 and PA66.

2. The composition according to claim 1, wherein said impact modifier is selected from a polyether block amide (PEBA), a functionalized or non-functionalized polyolefin and mixtures thereof.

3. The composition according to claim 1, wherein the impact modifier is selected from a polyether block amide (PEBA) having a flexural modulus less than 100 MPa as measured according to standard ISO 178:2010 at 23° C., and a mixture of polyether block amide (PEBA) having a flexural modulus less than 100 MPa as measured according to standard ISO 178:2010 at 23° C. with a functionalized or non-functionalized polyolefin.

4. The composition according to claim 3, wherein the PEBA has a density greater than or equal to 1, as determined according to ISO 1183-3: 1999.

5. The composition according to claim 1, wherein the impact modifier is selected from a functionalized polyolefin, a non-functionalized polyolefin and mixtures thereof, said impact modifier being present from 7 to 20.0% relative to the total weight of the composition.

6. The composition according to claim 3, wherein the functionalized polyolefin has a function selected from the maleic anhydride, carboxylic acid, carboxylic anhydride and epoxide functions.

7. The composition according to claim 1, wherein the carbon fibers are short carbon fibers having a fiber length comprised from 100 to 600 μm, said length being measured after compounding in the composition to be molded.

8. The composition according to claim 1, wherein the hollow glass beads have a mean volume diameter d₅₀ from 10 to 80 μm, as measured by laser diffraction according to ASTM B 822-17.

9. The composition according to claim 1, wherein the hollow glass beads have a real density of 0.10 to 0.65 g/cm³, measured according to ASTM D 2840-69 (1976) with a gas pycnometer and helium as the measuring gas.

10. The composition according to claim 1, wherein the hollow glass beads have a compression resistance, as measured according to ASTM D 3102-72 (1982) in glycerol of at least 50 MPa.

11. The composition according to claim 1, wherein the semi-crystalline polyamide is obtained by polycondensation:
of at least one C₆ to C₁₈ amino acid, or
of at least one C₆ to C₁₈ lactam, or
of at least one C₄-C₃₆ aliphatic diamine Ca with at least one C₄-C₃₆ aliphatic dicarboxylic acid Cb, or
a mixture thereof.

12. The composition according to claim 1, wherein the semi-crystalline polyamide is obtained by polycondensation:
of at least one C₆ to C₁₈ amino acid, or
of at least one C₆ to C₁₈ lactam.

13. The composition according to claim 1, wherein said semi-crystalline polyamide is selected from is selected from PA610, PA612, PA1010, PA1012, PA1212, PA11 and PA 12.

14. The composition according to claim 1, wherein said semi-crystalline polyamide is selected from PA11 and PA12.

15. (canceled)

16. A use of a composition as defined in claim 1, for the manufacture of an article for electronics, sports, motor vehicles or industry.

17. The use according to claim 16, wherein the article is manufactured by injection molding.

18. An article obtained by injection molding with a composition as defined in claim 1.

19. A molding composition, comprising by weight:
(A) from 38 to 79.5% of at least one semi-crystalline aliphatic polyamide,
(B) from 10 to 20% of carbon fibers,
(C) from 10 to 20% of hollow glass beads,
(D) from 5.5% to 20% of at least one impact modifier having a flexural modulus of less than 200 MPa, as measured according to standard ISO 178:2010 at 23° C., and
(E) from 0.1 to 1% by weight of at least one additive selected from the fillers selected from silica, graphite, expanded graphite, carbon black, kaolin, magnesia, slag, talc, wollastonite, nanofillers (carbon nanotubes), pigments, metal oxides (titanium oxide), metals, dyes, stabilizers, plasticizers, surfactants, nucleating agents, pigments, brighteners, antioxidants, lubricants, flame retardants, natural waxes and mixtures thereof,
the sum of the proportions of each constituent (A)+(B)+(C)+(D)+(E) of said composition being equal to 100%,
excluding PA6 and PA66, and
wherein the impact modifier is selected from a polyether block amide (PEBA) having a flexural modulus less than 100 MPa as measured according to standard ISO 178:2010 at 23° C., and a mixture of polyether block amide (PEBA) having a flexural modulus less than 100 MPa as measured according to standard ISO 178:2010 at 23° C. with a functionalized or non-functionalized polyolefin.

20. A molding composition, comprising by weight:
(A) from 38 to 79.5% of at least one semi-crystalline aliphatic polyamide,
(B) from 10 to 20% of carbon fibers,
(C) from 10 to 20% of hollow glass beads,
(D) from 5.5% to 20% of at least one impact modifier having a flexural modulus of less than 200 MPa, as measured according to standard ISO 178:2010 at 23° C., and
(E) from 0.1 to 1% by weight of at least one additive selected from the fillers selected from silica, graphite, expanded graphite, carbon black, kaolin, magnesia, slag, talc, wollastonite, nanofillers (carbon nanotubes), pigments, metal oxides (titanium oxide), metals, dyes, stabilizers, plasticizers, surfactants, nucleating agents, pigments, brighteners, antioxidants, lubricants, flame retardants, natural waxes and mixtures thereof,
the sum of the proportions of each constituent (A)+(B)+(C)+(D)+(E) of said composition being equal to 100%,
excluding PA6 and PA66, and
excluding nano alumina.
